(19) United States
(12) Patent Application Publication
(10) Pub. No.: US 2014/0108070 A1
(43) Pub. Date: Apr. 17, 2014

(54) USING MULTI-DESTINATION SEARCHES TO FACILITATE THE PURCHASE OF TRAVEL ITINERARIES

(71) Applicant: GetGoing, Inc., San Francisco, CA (US)

(72) Inventors: Alek Vernitsky, San Francisco, CA (US); Ilya Gluhovsky, Daly City, CA (US); Alek Strygin, Foster City, CA (US)

(73) Assignee: GetGoing, Inc., San Francisco, CA (US)

(21) Appl. No.: 14/051,220

(22) Filed: Oct. 10, 2013

Related U.S. Application Data
(60) Provisional application No. 61/712,345, filed on Oct. 11, 2012.
(60) Provisional application No. 61/712,347, filed on Oct. 11, 2012.

(51) Int. Cl. G06Q 10/02

(52) U.S. Cl. CPC G06Q 10/025
USPC 705/6

(57) ABSTRACT

The disclosed embodiments provide a system that facilitates a purchase of a travel itinerary. During operation, the system obtains a query containing one or more destination preferences provided by a user for the travel itinerary, wherein the one or more destination preferences include at least one of a region and an experience. Next, the system matches the one or more destination preferences to a set of destinations and generates a ranking of the destinations based on a set of criteria associated with the query. The system then uses the set of destinations to perform a search of available travel itineraries matching the query. Finally, the system provides the available travel itineraries to the user based on the ranking.

### RELATED APPLICATION

This application claims the benefit of U.S. Provisional Application No. 61/712,345, Attorney Docket Number GG12-1006PSP, entitled “Method and Apparatus for a Multi-Destination Flight Search User Interface,” by inventors Alek Vernitsky, Ilya Gluhovsky and Alek Strygin, filed 11 Oct. 2012, which is incorporated herein by reference.

This application claims the benefit of U.S. Provisional Application No. 61/712,347, Attorney Docket Number GG12-1007PSP, entitled “System and Method for Multi-Destination Flight Search Relevance,” by inventors Alek Vernitsky, Ilya Gluhovsky and Alek Strygin, filed 11 Oct. 2012, which is incorporated herein by reference.

The subject matter of this application is related to the subject matter in a co-pending non-provisional application by inventors Alek Vernitsky, Alek Strygin and Ilya Gluhovsky, entitled “System and Method for Facilitating the Purchase of a Travel Itinerary Subject to Destination Uncertainty,” having Ser. No. 13/656,458 and filing date 19 Oct. 2012 (Attorney Docket No. GG12-1001).

### BACKGROUND

1. Field

The disclosed embodiments relate to techniques for facilitating the purchase of a travel product. More specifically, the disclosed embodiments relate to techniques for facilitating the purchase of travel itineraries using multi-destination searches.

2. Related Art

Fare aggregators and/or meta-search engines are commonly used to research and/or book travel itineraries such as flights. By allowing users to browse itineraries from multiple airlines, online travel agencies, and/or other travel booking sources, a fare aggregator and/or meta-search engine may simplify and/or streamline the travel booking process for the users. For example, a fare aggregator and/or meta-search engine may allow a user to find a cheaper fare for a travel itinerary without manually searching and comparing fares from multiple airlines and/or travel websites.

In addition, a significant portion of discretionary travelers may research multiple destinations before settling on a destination and booking a travel itinerary to the destination. For example, a traveler booking a beach-oriented vacation may research flights, lodging, activities, and/or other attributes associated with multiple beach destinations. The traveler may book the flights, lodging, and/or other travel services for the vacation only after the traveler has found a beach destination with travel, lodging, and/or other attributes that meet the traveler's budget, schedule, goals, and/or preferences.

However, conventional travel websites, including fare aggregators and meta-search engines, typically do not allow users to search multiple destinations for flight itineraries. Instead, a user may be required to independently search each destination from a set of potential destinations to obtain availability and prices for travel itineraries to the destination. The user may then compare prices and/or schedules for travel to the potential destinations across multiple searches and/or browser windows containing search results of the searches. Moreover, the user may not be aware of other destinations that may match the user's travel needs and preferences unless the user manually researches the destinations using resources (e.g., guide books, travel information websites, forums, etc.) outside of mechanisms used to search and/or book travel itineraries to the destinations (e.g., airline websites, fare aggregators, meta-search engines, etc.).

Consequently, travelers with destination flexibility may expend significant time and effort in planning and booking travel using existing travel search and booking tools.

### SUMMARY

The disclosed embodiments provide a system that facilitates a purchase of a travel itinerary. During operation, the system obtains a query containing one or more destination preferences provided by a user for the travel itinerary, wherein the one or more destination preferences include at least one of a region and an experience. Next, the system matches the one or more destination preferences to a set of destinations and generates a ranking of the destinations based on a set of criteria associated with the query. The system then uses the set of destinations to perform a search of available travel itineraries matching the query. Finally, the system provides the available travel itineraries to the user based on the ranking.

In some embodiments, upon receiving the available travel itineraries from the search, the system updates the ranking of the destinations based on at least one of a schedule and a price associated with each of the available travel itineraries.

In some embodiments, the system also obtains a set of refinements to the one or more destination preferences based on the one or more destination preferences. Next, the system provides the set of refinements to the user. Finally, the system updates the one or more destination preferences with a selection of a refinement from the set of refinements by the user prior to matching the one or more destination preferences to the set of destinations.

In some embodiments, the set of refinements includes one or more regions, one or more experiences, and/or one or more sub-regions.

In some embodiments, generating the ranking of the destinations based on the set of criteria involves using the criteria to calculate a set of match scores for the set of destinations, and ordering the destinations by the match scores.

In some embodiments, using the set of destinations to perform the search of available travel itineraries matching the query involves searching the available travel itineraries for a subset of the ordered destinations associated with higher match scores.

In some embodiments, providing the available travel itineraries to the user based on the ranking involves at least one of:
(i) displaying the destinations associated with the available travel itineraries according to the ordering of the destinations;
(ii) enabling searching of one or more destinations from a remainder of the ordered destinations not in the subset of the ordered destinations;
(iii) displaying a cheapest price for booking the travel itinerary to each of the destinations;
(iv) filtering the displayed destinations by the match scores;
(v) updating the displayed destinations based on input from the user; and
(vi) updating the ordering of the destinations based on a property associated with the available itineraries.

In some embodiments, the input is associated with at least one of a destination, a travel option, and a user action.

In some embodiments, the one or more destination preferences further include a search operator.

In some embodiments, the set of criteria is associated with at least one of the region, the experience, a primary season, a length of stay, a distance between an origin and a destination of the travel itinerary, a time difference between the origin and destination, a popularity, a traveler-friendliness, a child-friendliness, a price, a schedule convenience, and a user preference.

### BRIEF DESCRIPTION OF THE FIGURES

FIG. 1 shows a schematic of a system in accordance with the disclosed embodiments.

FIG. 2 shows a system for facilitating a purchase of a travel itinerary in accordance with the disclosed embodiments.

FIG. 3 shows the generation of a set of available travel itineraries from one or more destination preferences in accordance with the disclosed embodiments.

FIG. 4A shows an exemplary screenshot in accordance with the disclosed embodiments.

FIG. 4B shows an exemplary screenshot in accordance with the disclosed embodiments.

FIG. 4C shows an exemplary screenshot in accordance with the disclosed embodiments.

FIG. 5 shows a state diagram for a search result in a results module in accordance with the disclosed embodiments.

FIG. 6 shows a flowchart illustrating the process of facilitating a purchase of a travel itinerary in accordance with the disclosed embodiments.

FIG. 7 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

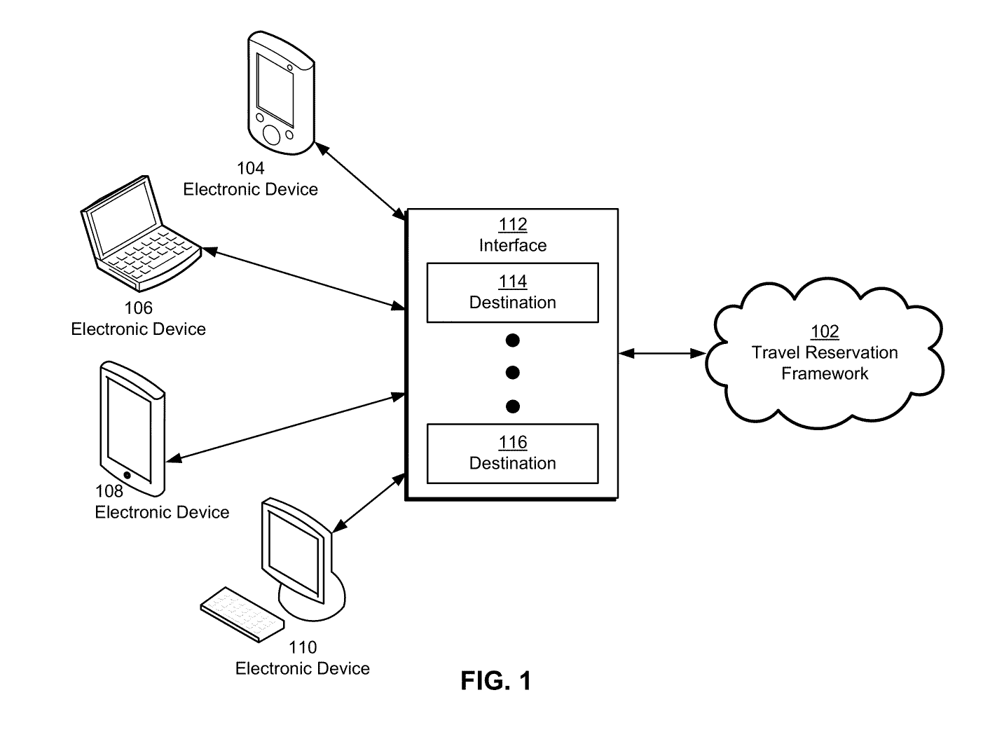

The disclosed embodiments provide a method and system for facilitating the purchase of a travel itinerary such as a ticket for a flight, train, bus, ferry, and/or other method of transport. More specifically, the disclosed embodiments provide a method and system for facilitating the purchase of travel itineraries using multi-destination searches. As shown in FIG. 1, a set of destinations 114-116 may be searched through an interface 112 that is accessed by a set of users (e.g., “buyers”) through a set of electronic devices 104-110. For example, interface 112 may be a graphical user interface (GUI), web-based user interface, touch-based user interface, and/or other type of user interface that is provided by a web browser, mobile application, native application, and/or other application executing on a mobile phone, personal computer, laptop computer, personal digital assistant, tablet computer, portable media player, and/or other type of network-enabled electronic device.

Destinations 114-116 may be provided by a travel reservation framework 102 that is accessed through interface 112. For example, travel reservation framework 102 may allow the users to specify an origin, one or more destinations 114-116, a departure date, a return date, flexible dates, a length of stay, a number of travelers, a traveler type (e.g., adult, child, senior, etc.), a class of service, and/or other search parameters related to booking travel. After obtaining the search parameters from a user through the user's electronic device (e.g., electronic devices 104-110) and interface 112, travel reservation framework 102 may perform searches of multiple airlines, online travel agencies, search engines, and/or other travel booking sources for travel itineraries that match the search parameters. Travel reservation framework 102 may then provide information related to the matching travel itineraries (e.g., price, schedule, number of stops, duration, operating carrier, etc.) as search results to the user through interface 112. After the user has selected a suitable travel itinerary from the search results, travel reservation framework 102 may allow the user to book the travel itinerary, either through interface 112 or by redirecting the users to websites and/or other booking mechanisms of the airlines, online travel agencies, and/or other travel-related service providers.

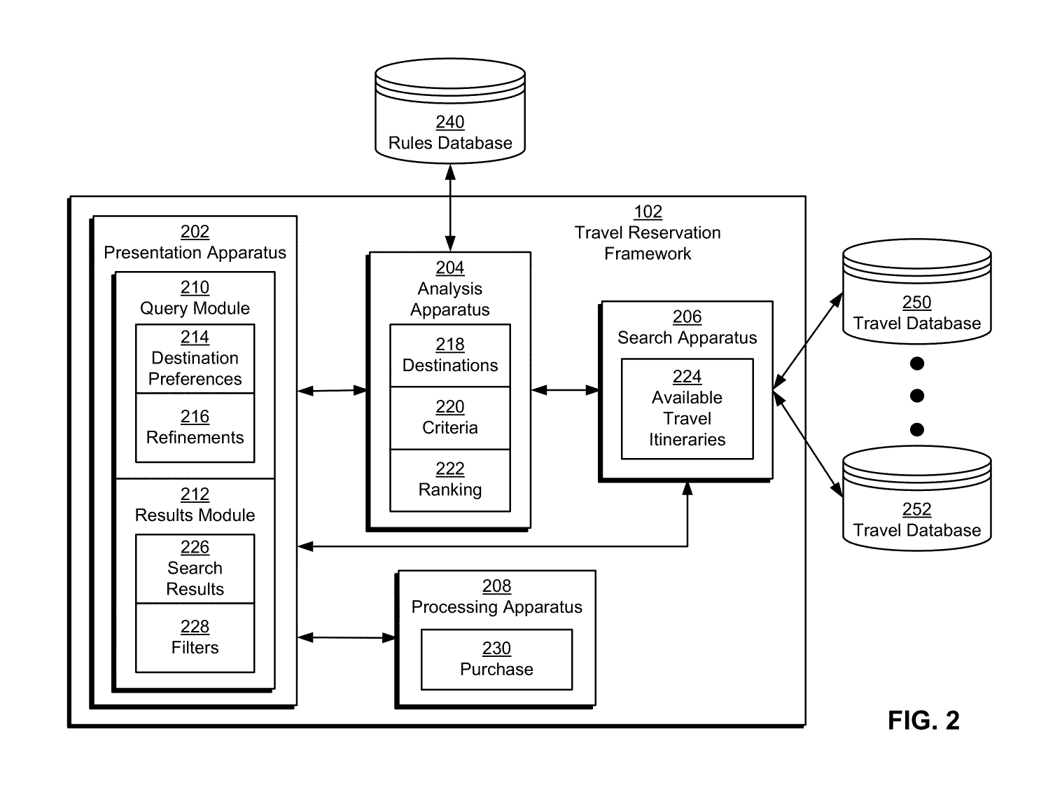

To enable searching of multiple destinations 114-116 using a single query, travel reservation framework 102 may accept search parameters that match multiple destinations 114-116 in the same or different geographic areas. As shown in FIG. 2, a presentation apparatus 202 in travel reservation framework 102 may include a query module 210 that obtains a query containing one or more destination preferences 214 from a user. To interact with the user, presentation apparatus 202 may provide a user interface that is accessed through an electronic device of the user, such as interface 112 of FIG. 1.

Destination preferences 214 may describe a set of destinations 218 to be searched using the query. For example, destination preferences 214 for flights may include one or more explicit destinations, such as specific airports and/or metropolitan areas that that include multiple airports. Query module 210 may also allow the user to provide more general destination preferences 214, including regions and/or experiences. Regions may include continents and/or countries, such as “Africa and the Middle East,” “Asia,” “Australia and the Pacific,” “Central and South America,” “Europe,” “Mexico and the Caribbean,” and/or “United States and Canada.” Experiences may relate to activities, sights, environment, and/or types of travel, such as “Adventure and Outdoors,” “Beaches and Sun,” “Family Fun,” “History and Culture,” “Romance,” “Shopping,” and/or “Skiing.”

To facilitate searches that are narrower and/or more relevant to the user's preferences, query module 210 may also obtain one or more refinements 216 to destination preferences 214 from the user. In particular, query module 210 may use destination preferences 214 inputted by the user to identify and/or retrieve a set of refinements 216 that are relevant to destination preferences 214. Refinements 216 may include regions, experiences, and/or sub-regions that are pertinent to the region(s) and/or experience(s) already specified in destination preferences 214. In turn, refinements 216 may be used to “focus” the search on a subset of destinations matching a more specific set of destination preferences 214 and/or increase the relevance of search results 226 matching the query to the user's actual travel preferences.

For example, refinements 216 for a “United States” destination preference may include “Big Cities and Entertainment,” “Beach,” “Outdoors,” and “Skiing” to match the destination preference to one of several relatively disparate sets of destinations. Refinements 216 for a “Europe” destination preference may include mostly non-overlapping sub-regions such as “UK,” “Germany,” “France,” “Netherlands,” “Southern Europe,” “Scandinavia,” “Other Western Europe,” and “Eastern Europe” instead of experiences like “History and Culture” or “Shopping,” which may be shared by most European destinations.

Refinements 216 for a destination preference may also include a mix of regions and experiences. For example, refinements 216 for a “Central America & the Caribbean” destination preference may include “Popular Destinations,” “Exotic Destinations,” “Best Beaches,” “Animal Watching,” and “Active Outdoors.” Refinements 216 for a “South America” destination preference may include “History and Culture,” “Jungle/Amazon/Trekking,” and “Partying and Entertainment.” Refinements for an “Asia and Pacific” destination preference may include “Japan,” “China,” “Australia & New Zealand,” “Pacific Islands,” “Beach,” “Outdoors,” “Partying and Entertainment,” “Exotic Destinations,” and “History and Culture.” Refinements 216 for a “Middle East and Africa” destination preference may include “Middle East,” “North Africa,” “Sub-Saharan Africa,” “Animal Watching,” and “History and Culture.”

To facilitate narrowing of destination preferences 214 in a meaningful way, refinements 216 may be provided by an expert system associated with travel reservation framework 102. Refinements 216 may also be updated using multivariate testing and/or reinforcement learning techniques to improve the usefulness of multi-destination searches for the user and/or other users over time.

After query module 210 obtains the set of refinements 216 to destination preferences 214, query module 210 may display refinements 216 to the user (e.g., using one or more user-interface elements) and allow the user to select one or more of the displayed refinements 216 (e.g., by interacting with the user-interface elements). For example, query module 210 may provide refinements 216 as one or more follow-up questions related to destination preferences 214. Query module 210 may then update destination preferences 214 with the user's answer(s) to the follow-up questions.

Alternatively, query module 210 may allow the user to generate a targeted search query using a combination of destinations, regions, experiences, sub-regions, and/or other destination-related search parameters. For example, query module 210 may show the user a set of pre-defined and/or popular regions and/or experiences and allow the user to select one or more regions (e.g., “Asia,” “Australia and the Pacific”) and/or one or more experiences (e.g., “Beaches and Sun”) to search. After the user selects a region or experience, query module 210 may gray out other experiences or regions that are not relevant to the selection. The query may then be constructed to search for destinations in the selected regions that also match one or more of the selected experiences (e.g., (“Asia” OR “Australia and the Pacific”) AND “Beaches and Sun”).

Query module 210 may further allow the user to perform an advanced search of regions and/or preferences using a single search field and one or more search operators. Continuing with the above example, the user may type “(Asia OR Australia and the Pacific) AND Beaches and Sun)” into the search field to generate the same query as selecting the respective regions and experience. The user may also add specific destinations (e.g., airport codes) to the query to increase the importance of the destinations by inputting, for example, “(Asia OR Australia and the Pacific OR DPS OR SYD) AND Beaches and Sun).” The user may also specify other search parameters using search operators, such as operating carriers (e.g., “airline:XYZ Airlines”), price ranges (e.g., “$500 . . . $1500”), and/or other information that may be relevant to the search. In other words, query module 210 may include functionality to obtain destination preferences 214 and/or refinements 216 in a number of ways (e.g., basic search, guided follow-up questions, advanced queries) and/or from various types of users (e.g., novice, advanced, etc.).

Finally, query module 210 may enable searching based on other groupings of destinations 218. For example, query module 210 may allow the user to specify destination preferences 214 for date-specific events, such as film festivals, wine competitions, carnivals, and/or antique fairs. Because such events may be spread across different dates, query module 210 may include functionality to search multiple destinations related to a specific type of event across multiple dates on which events of that type take place in the respective destinations. Query module 210 may also include pre-defined lists of destinations in destination preferences 214, such as lists of destinations related to UNESCO World Heritage sites, the European Route of Industrial Heritage, ancient or modern wonders of the world, and/or “Places to See Before You Die.” Along the same lines, query module 210 may allow the user to create a custom list of destinations to be searched by adding specific destinations to the list and/or specifying attributes associated with the destinations (e.g., weather, latitude, longitude, population, biomes or ecosystems, religion, government, cost, language, etc.).

Finally, query module 210 may allow the user to search groupings of airports in the same metropolitan area. To generate the groupings, a list of airports sorted by popularity (e.g., flight volume) in descending order may be used to identify the most popular airports in a particular region. For example, the most popular airports in the United States may include the following airports in descending order of flight volume based on originating flights: ATL, ORD, LAX, DFW, DEN, JFK, PHX, IAH, LAS, CLT, SFO, MIA, and EWR. Next, an “area” around each of the most popular airports is created by specifying a radius (e.g., 50 miles) around the airport. For each remaining airport in the ordered list, the distance of the airport to each of the most popular airports is calculated in descending order of popularity until the airport is identified to be in the area of one of the most popular airports. As a result, the airport may be included in the area of the largest airport in the airport's vicinity. Alternatively, if the airport does not belong to any pre-defined areas, a new area centered on the airport is created. Such a grouping technique may produce the following groupings using the airports in the previous example:
[ORD, MDW, GYY, PWK, UGN, LOT, CHI, DPA]
[LAX, SNA, ONT, BUR, LGB, VNY, NTD, SMO, OXR]
[DEN, FNL, APA, BJC]
[JFK, EWR, LGA, HPN, ISP, TEB, MMU, NYC, CDW]
[SFO, OAK, SJC, CCR, NUQ]
[PHX, AZA]
[LAS, VGT, HSH, LSV]
[CLT, HKY]
[MIA, FLL, BCT, OPF, TMB, FXE, OCA],
   where the center airport is shown in bold.

Query module 210 may then complete the query with additional search parameters from the user. For example, query module 210 may receive specific dates, flexible dates, and/or date ranges to search from the user. Query module 210 may also ask the user to specify a class of service, number of passengers, and/or types of passengers (e.g., adults, children, seniors, etc.) to be included in the query.

Once destination preferences 214 and/or refinements 216 are obtained from the user, an analysis apparatus 204 in travel reservation framework 102 may match destination preferences 214 to the set of destinations 218. Such matching may be performed after the user submits the query or while the user provides destination preferences 214 and/or refinements 216. For example, analysis apparatus 204 may perform the matching once per query, after the query is constructed from destination preferences 214 and/or refinements 216. Conversely, analysis apparatus 204 may continuously update the set of matching destinations 218 as the user selects and/or specifies regions, sub-regions, and/or experiences to search within query module 210. As a result, analysis apparatus 204 may maintain a count of the matching destinations 218 during use of query module 210 by the user, which in turn may facilitate the selection and use of refinements 216 (e.g., as a series of follow-up questions) in reducing the count until a threshold is reached.

After the set of matching destinations 218 is finalized (e.g., after the user submits the query through query module 210), analysis apparatus 204 may generate a ranking 222 of destinations 218 based on a set of criteria 220 associated with the query. Criteria 220 may be associated with destination preferences 214 (e.g., regions and/or experiences), a primary season, a length of stay, a distance between the origin provided in the query and a destination, a time difference between the origin and destination, a popularity of the destination, a traveler-friendliness, a child-friendliness, a price, a schedule convenience, and/or a user preference.

More specifically, analysis apparatus 204 may generate ranking 222 by using criteria 220 to calculate a set of match scores for destinations 218 and ordering destinations 218 by the match scores. For example, analysis apparatus 204 may order destinations 218 by descending match scores so that the highest-matching destinations appear at the top of ranking 222.

In addition, criteria 220 may be specified using a set of rules from a rules database 240. The rules may describe the suitability of destinations 218 based on a variety of parameters of the query. First, the rules may identify the regions, sub-regions, and/or experiences that are relevant to a particular destination and require that the destination's region, sub-region and/or experience(s) match one or more destination preferences 214 and/or refinements 216 from the query.

Next, the rules may initially calculate the destination's match score based on the “strength” of a match between the destination and an experience, as determined by the desired attributes of the experience and the attributes of the destination. For example, a “Beaches” experience may be associated with warm water, warm weather, and/or sandy and/or protected beaches. A beach destination's match score may have a higher initial match score if the destination conforms to the attributes of the “Beaches” experience and a lower initial match score if the destination is associated with cool weather, cold water, and/or rocky or unprotected beaches. If the query is strictly region-based and does not include experiences, an initial match score for a destination may be calculated by summing the destination's experience-based match scores. For example, if a destination scores 1.0 on “Romance,” 1.0 on “History and Culture,” and 0.7 on “Shopping,” the destination's initial match score may be 2.7.

The rules may also define a primary season for the destination and penalize a destination's match score if the dates of the query are outside the primary season. On the other hand, the rules may override the primary season if destination preferences 214 are not relevant to the primary season. For example, a primary season for a European destination may be in the summer. As a result, the European destination's match score may be penalized if the query is for winter travel, unless the query included an experience such as “Skiing” that overrides the primary season. If the query is for summer travel, the European destination's match score may be increased, with a higher increase for travel in the peak of the primary season than travel at the boundary of the primary season.

The rules may further compare the length of stay specified in the query with the typical length of stay at the destination, given the origin of the query. The destination's match score may be increased if the lengths of stay match well and decreased if the lengths of stay do not match well. For example, a query for a departure from North America to a beach-oriented destination may match a Caribbean or Mexican beach destination well if the query's length of stay is less than a week, while the query may better match an Asian or Australian beach destination if the query's length of stay is longer than two or three weeks.

Similarly, the rules may favor destinations that are easier to get to over destinations that are harder to reach. For example, the rules may be favorable to destinations that are geographically closer to the origin, separated from the origin by fewer time zones, require fewer connections to reach, and/or require less overall travel time to reach. Such distance- and/or schedule-based rules and/or criteria 220 may be based on historical travel itineraries between the origin and the destinations. The same rules and/or criteria may also be reapplied after the schedules of available travel itineraries 224 between the origin and the destinations are obtained, as described in further detail below.

The rules may additionally be based on general attributes such as popularity, traveler-friendliness, child-friendliness, ease of travel, ease of communication, and/or value of money. For example, destinations that are popular, easy to get around, populated with English speakers, tourist-friendly, and/or good value may be ranked higher than destinations that are less popular, harder to get around, less tourist-friendly, populated with non-English speakers, and/or expensive. The rules may also factor in the child-friendliness of each destination in the calculation of the match scores if children are included as travelers in the query and increase the weight of the destination's child-friendliness with the number of children in the query.

Finally, the rules may allow ranking 222 to be customized to the user's preferences. For example, the user may explicitly specify preferences such as a strong preference for nonstop travel itineraries, sensitivity to long travel times, a preference for highly reputable destinations, a preference for exotic destinations, a willingness to travel on a passport, a willingness to travel on a visa, a preference for traveler-friendly destinations, and/or a preference for domestic destinations. Such user preferences may be included in the user's profile, provided in the query, and/or otherwise obtained from the user. The destinations' match scores may then be adjusted to accommodate the user preferences.

The user preferences may also be implicitly inferred from the user's previous searches, bookings, and/or other actions with travel reservation framework 102. For example, the user's sensitivity to long travel times may be detected based on the user's unwillingness to search faraway destinations and/or book travel itineraries that are longer than a certain number of hours. Similarly, the user's preference for destinations in a specific region may be inferred from the user's addition of a specific destination in the region to destination preferences 214 instead of the user's inclusion of the region in destination preferences 214.

As with refinements 216, criteria 220 and/or the associated rules may initially be provided by an expert system. The rules may then be updated using a regression and/or learning technique that identifies the relationship between user success events such as clicks, shopping cart placements, and/or purchases (e.g., purchase 230) of travel itineraries and criteria 220. The rules may further be customized to the user as the user's preferences are obtained and/or inferred over time.

Once ranking 222 is made, a search apparatus 206 in travel reservation framework 102 may use destinations 218 to perform a search of available travel itineraries 224 matching the query. During the search, search apparatus 206 may query multiple travel databases 250-252 and aggregate results from travel databases 250-252 in available travel itineraries 224. For example, search apparatus 206 may search multiple travel provider websites, global distribution systems (GDSes), central reservation systems (CRSes), online travel agencies, and/or other sources of travel itineraries to obtain available travel itineraries 224. In addition, search apparatus 206 may search available travel itineraries 224 for a subset of destinations 218 based on ranking 222. For example, search apparatus 206 may search the subset of destinations 218 with higher match scores (e.g., at the top of ranking 222) and omit searching the remainder of destinations 218 that do not have high-enough match scores and/or fall outside a threshold for the number of destinations 218 to search at a time.

Analysis apparatus 204 may then update ranking 222 based on the prices and/or schedules of available travel itineraries 224. For example, analysis apparatus 204 may apply rules from rules database 240 to balance the relevance of destinations 218 to the query with the prices and schedules of available travel itineraries 224 to destinations 218. To update ranking 222, analysis apparatus 204 may update the destination's match score, as calculated before searching available travel itineraries 224, using criteria 220 associated with the prices and/or schedules of one or more available travel itineraries 224 (e.g., cheaper (-est) itinerary among all the searched destinations, direct flight availability, faster (-est) itinerary, departure time flexibility, choice of airline, convenient connections, etc.) to the destination. Such updating of the match score may be based on rules that are provided and/or updated using an expert and/or learning system and stored in rules database 240. Destinations 218 may then be re-ranked according to the updated match scores.

A results module 212 in presentation apparatus 202 may then provide available travel itineraries 224 as search results 226 for the query to the user. Within results module 212, search results 226 may be grouped by destination and ordered by ranking 222, with destinations 218 associated with higher match scores appearing higher than destinations 218 associated with lower match scores. For example, search results 226 may be provided as a set of vertically stacked “blocks,” with each block containing a summary of available travel itineraries 224 (e.g., number of flights, cheapest flight, etc.) to the corresponding destination. Search results 226 may also be filtered by the destinations' match scores to reduce the number of destinations shown to the user and/or prevent destinations with match scores below a pre-specified threshold from being shown.

Alternatively, search results 226 may include a list of travel itineraries to matching destinations 218 that are sorted by price, schedule, number of stops, operating carrier, and/or another attribute. The itineraries may be color-coded and/or otherwise marked to identify travel itineraries to the same destinations.

Results module 212 may also update the displayed destinations 218 based on input from the user. First, results module 212 may provide a set of filters 228 for updating and/or filtering search results 226. For example, filters 228 may be used by the user to filter and/or sort search results 226 by departure time, arrival time, total travel time, number of stops, price, operating carrier, operating carrier alliances, destinations visited by the user's contacts (e.g., friends, family members, acquaintances, etc.), destinations visited by the user, geographic region, name, and/or other travel options or attributes associated with available travel itineraries 224. Filters 228 may also be preset based on the user's implicit and/or explicit preferences, as obtained from the user's settings and/or previous interaction with travel reservation framework 102. For example, filters 228 may be set to prevent lengthy itineraries to be shown in search results 226 if the user is explicitly or implicitly sensitive to trip duration.

Results module 212 may also allow the user to modify the displayed search results 226. For example, results module 212 may provide a field that may be used to add specific destinations to search results 226 (e.g., thus triggering a search of available travel itineraries 224 to the destinations). The user may then manipulate additional search results 226 related to the added destinations. On the other hand, the user may hide or remove one or more destinations from search results 226 if the destination(s) are not relevant to the user's travel plans and/or preferences.

Moreover, results module 212 may automatically update search results 226 based on the user's actions and/or interaction with presentation apparatus 202. As described above, the user's previous actions and/or searches with travel reservation framework 102 may be used to generate ranking 222. Similarly, the user's actions through results module 212 may be used to modify the order of search results 226. For example, the user's addition of a destination to search results 226 may cause similar destinations to appear higher in search results 226 and/or trigger the addition of the similar destinations to search results 226, if the similar destinations weren't already in search results 226.

One or more refinements 216 may also be obtained by results module 212, in addition to or in lieu of any refinements 216 obtained by query module 210. For example, search apparatus 206 may perform the search of available travel itineraries 224 with an initial set of destination preferences 214 from query module 210. As results module 212 presents search results 226 for available travel itineraries 224 to the user, results module 212 may prompt the user to provide one or more refinements 216 (e.g., sub-regions of a region with large number of destinations in search results 226), which may be based on search results 226 and used to further infer the user's intent. Results module 212 may then augment and/or re-rank the displayed destinations 218 in search results 226 based on the newly obtained refinements 216.

As described above, available travel itineraries 224 may not be searched for all destinations 218 that match destination preferences 214 and/or refinements 216. Instead, a subset of destinations 218 that highly match destination preferences 214 may be searched, and available itineraries 224 for the subset may be included in search results 226. To increase the flexibility of the search, results module 212 may enable searching of the remainder of destinations 218 not in the subset by the user. For example, results module 212 may provide a list of checkboxes for destinations not included in search results 226, with the user's selection of a checkbox triggering a search for additional available travel itineraries 224 to the corresponding destination. The user's selection may also be used to update criteria that are used to generate ranking 222 for subsequent searches by the user and/or other users.

Results module 212 may also allow the user to view and access subsets of available travel itineraries 224 to specific destinations. For example, results module 212 may allow the user to select a destination in search results 226 to access a modal window containing a subset of available travel itineraries 224 to the selected destination. As with search results, the modal window may include filters 228 for filtering the subset of available travel itineraries 224 by departure time, arrival time, total travel time, number of stops, price, operating carrier, operating carrier alliances, and/or other travel options. Travel options and/or filters 228 specified within the modal window may then be applied to the subset of available travel itineraries 224 but not to other available travel itineraries 224 or destinations 218 in search results 226.

The user may thus browse, filter, sort, and/or modify search results 226 in results module 212 until the user finds a travel itinerary that matches the user's budget, schedule, and/or other travel preferences. The user may select the travel itinerary in results module 212, and a processing apparatus 208 in travel reservation framework 102 may process a purchase 230 of the travel itinerary for the user. For example, presentation apparatus 202 and/or processing apparatus 208 may confirm the details of purchase 230 (e.g., dates, schedule, origin, destination, number of travelers, prices, etc.) with the user, obtain payment (e.g., credit card, debit card, electronic check, online payment) information from the user, and perform purchase 230 by booking the travel itinerary using the payment information. Alternatively, presentation apparatus 202, processing apparatus 208, and/or another component of travel reservation framework 102 may redirect the user to a third-party website and/or booking mechanism through which the user may purchase 230 the travel itinerary.

Those skilled in the art will appreciate that the user may perform multiple searches with travel reservation framework 102 to evaluate alternatives during travel planning. During the search process, the user may hone in on a small number of destinations 218 from which to choose. To reduce overhead associated with performing multiple searches across a large set of destinations, analysis apparatus 204, search apparatus 206, and/or another component of travel reservation framework 102 may group similar queries made by the user that do not result in booking of travel itineraries and track the user's interest in individual destinations 218 across the queries. For example, an interest score may be calculated for each destination based on the user's level of interaction with the destination in results module 212 and updated as the user performs similar searches with travel reservation framework 102. The tracked interest levels may then be used to reduce the number of destinations searched and/or displayed by travel reservation framework 102, thus also reducing search costs, processing, and/or latency in travel reservation framework 102.

In one or more embodiments, multi-destination searches are performed by travel reservation framework 102 by sending third-party requests in parallel, accessing user contexts in real-time, and evaluating models associated with refinements 216, criteria 220, and/or ranking 222 in real-time. First, travel reservation framework 102 may send search requests for available travel itineraries 224 to travel databases 250-252 (e.g., GDSes, CRSes, travel provider websites, online travel agencies, etc.) in parallel to lower the user's wait time. In some cases, a travel database may accept groups of destinations within a single search request. For example, a GDS may provide a search engine with a multi-city option at the expense of a reduced number of search results per destination and reduced ability to control the proportions of search results across destinations.

As a result, travel reservation framework 102 may intelligently group destinations 218 into small sets to be sent within single third-party requests and transmit multiple such third-party requests in parallel. Travel reservation framework 102 may also send the top destinations 218 in ranking 222 in dedicated requests and group the remaining destinations 218 into distance “buckets” to aim for similar numbers of search results 226 per destination in each bucket. To send the third-party requests in parallel, travel reservation framework 102 may use a software threading library to spawn non-blocking long-polling threads, each of which sends a single third-party search request. Search apparatus 206, results module 212, and/or another component of travel reservation framework 102 may then determine when to return search results 226 to the user. For example, the component may choose to wait for a certain proportion (e.g., 80%) of search results 226 to be returned if the user has already waited for a pre-specified period (e.g., 20 seconds). The remaining search results 226 may then be loaded at the bottom of results module 212 as the search results are received.

Next, personalization of refinements 216, search results 226, filters 228, and/or other aspects of the multi-destination searches may require access to user information and context in real time, such as the user's profile, previous actions, explicit or implicit preferences, and/or social network data. The user context may also include the user's recent activity with travel reservation framework 102, such as activity during the user's current session with travel reservation framework 102. To enable real-time access to the user context, historical and recent information associated with the user context may be stored in a database cache, a database optimized for fast reads, and/or a browser cookie with the user's electronic device.

Finally, models (e.g., expert systems, learning techniques, etc.) associated with obtaining and/or providing refinements 216, criteria 220, and/or ranking 222 may affect the performance and/or latency of the multi-destination searches. Typical expert systems and/or regression models are generally capable of real-time evaluation. The models may also be accessible to other components of travel reservation framework 102 (e.g., presentation apparatus 202, analysis apparatus 204, search apparatus 206, etc.) by, for example, being included in the other components and/or wrapped in web services.

In one or more embodiments, travel reservation framework 102 includes functionality to combine multi-destination searches with an “alternative destinations” mechanism for purchasing a travel itinerary. The “alternative destinations” mechanism may allow the user to add two or more travel itineraries to different destinations to a shopping cart (e.g., provided by processing apparatus 208) and commit to purchasing at least one of the selected travel itineraries. Travel reservation framework 102 may then select one or more of the destinations in the shopping cart and process a purchase (e.g., purchase 230) of a travel itinerary associated with the selected destination(s) for the user before revealing the purchased travel itinerary to the user. Using an “alternative destination” mechanism to purchase a travel itinerary is described in a co-pending non-provisional application by inventors Alek Vernitsky, Alek Strygin and Ilya Gluhovsky, entitled “System and Method for Facilitating the Purchase of a Travel Itinerary Subject to Destination Uncertainty,” having Ser. No. 13/656,458 and filing date 19 Oct. 2012 (Attorney Docket No. GG12-1001), which is incorporated herein by reference.

Because multiple destinations are an inherent part of the “alternative destinations” mechanism, use of the “alternative destinations” mechanism may be facilitated by conducting one or more multi-destination searches of available discounted travel itineraries through travel reservation framework 102. The user may then add different destinations to the shopping cart for use with the “alternative destinations” mechanism using search results from the multi-destination searches.

By enabling multi-destination searches for the user, travel reservation framework 102 may allow the user to search for and/or identify available travel itineraries 224 that match the user's travel goals and/or intent without performing separate searches for travel to individual destinations. Moreover, the grouping of destinations 218 with similar attributes (e.g., region, experience, event, etc.) into destination preferences 214 may allow the user to discover and/or consider travel to destinations 218 without separately researching destinations 218 (e.g., using guidebooks, travel information websites, etc.). Finally, the use of refinements 216 and/or user-specific customizations in ranking 222 and/or presenting destinations 218 in search results 226 may increase the relevance and/or usefulness of search results to the user.

Those skilled in the art will appreciate that the system of FIG. 2 may be implemented in a variety of ways. First, presentation apparatus 202, analysis apparatus 204, search apparatus 206, processing apparatus 208, and/or rules database 240 may be provided by a single physical machine, multiple computer systems or electronic devices, one or more virtual machines, a grid, one or more databases, one or more filesystems, and/or a cloud computing system. In addition, presentation apparatus 202, analysis apparatus 204, search apparatus 206, and/or processing apparatus 208 may be implemented together or separately by one or more hardware and/or software components and/or layers.

In addition, regions, experiences, sub-regions, and/or other groupings may also be used to search multiple departure origins in addition to or in lieu of multiple destinations 218. For example, the user may specify a group of airports in a metropolitan area generated using the technique described above as a set of possible origins for travel to a set of destinations 218 associated with a certain region, experience, sub-region, and/or metropolitan area.

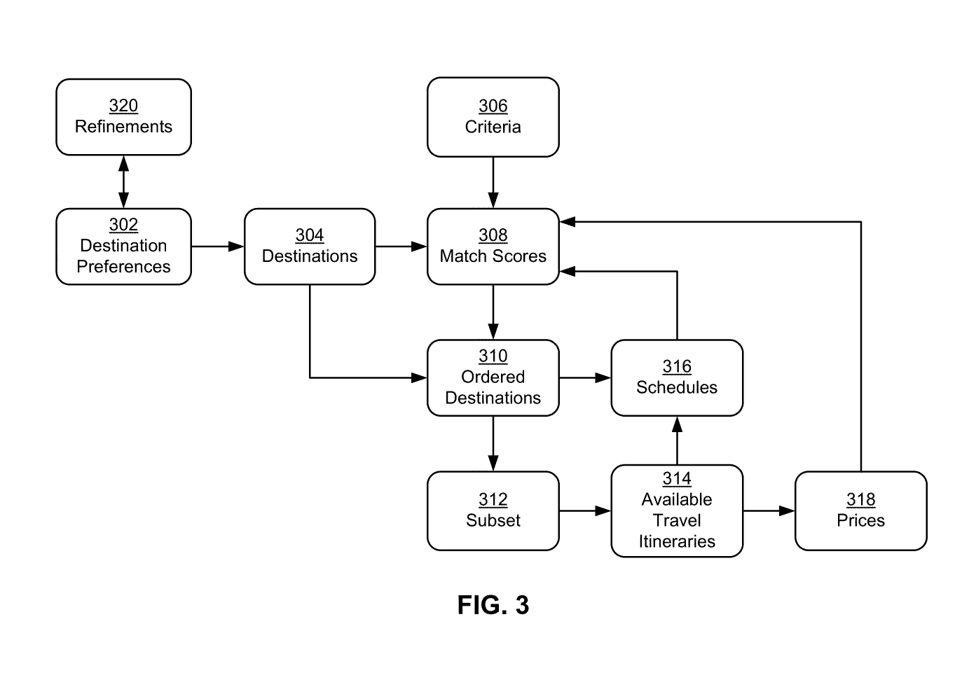

FIG. 3 shows the generation of a set of available travel itineraries 314 from one or more destination preferences 302 in accordance with the disclosed embodiments. As discussed above, destination preferences 302 may be obtained from a query provided by a user. Destination preferences 302 may also be updated with one or more refinements 320 to better match available travel itineraries 314 to the user's preferences, goals, and/or intent.

Next, destination preferences 302 are matched to a set of destinations 304. For example, destinations 304 may include specific destinations specified in destination preferences 302 and/or groups of destinations that conform to one or more destination preferences 302, such as a region and/or an experience.

A ranking of destinations 304 is generated based on a set of criteria 306 associated with the query. In particular, criteria 306 may be used to calculate a set of match scores 308 for destinations 304 and produce a set of ordered destinations 310. For example, criteria 306 may be associated with the region and/or experience specified in destination preferences 302, a primary season, a length of stay, a distance between the origin in the query and each destination, a time difference between the origin and destination, a popularity, a friendliness to a traveler type, a price, a schedule convenience, and/or a user preference. As a result, match scores 308 may reflect the desirability and/or suitability of travel to destinations 304 based on destination preferences 302, other search parameters in the query, and/or the user's preferences. Ordered destinations 310 may then be produced by ordering destinations 304 by match scores 308.

Available travel itineraries 314 may then be searched for a subset 312 of ordered destinations 310 associated with higher match scores 308. For example, the search may be performed with a certain number (e.g., 10, 20, 50, etc.) of ordered destinations 310 with the highest-ranking match scores 308 and/or a variable number of ordered destinations 310 with match scores 308 above a pre-specified threshold.

Once available travel itineraries 314 are available, the ranking may be updated with schedules 316 and/or prices 318 associated with available travel itineraries 314. For example, match scores 308 may be recalculated based on schedules 316 and/or prices 318 to improve the ranking of one or more searched destinations 304 with relatively cheap and/or short travel itineraries. Available travel itineraries 314 may then be provided to the user based on updated match scores 308, as described above.

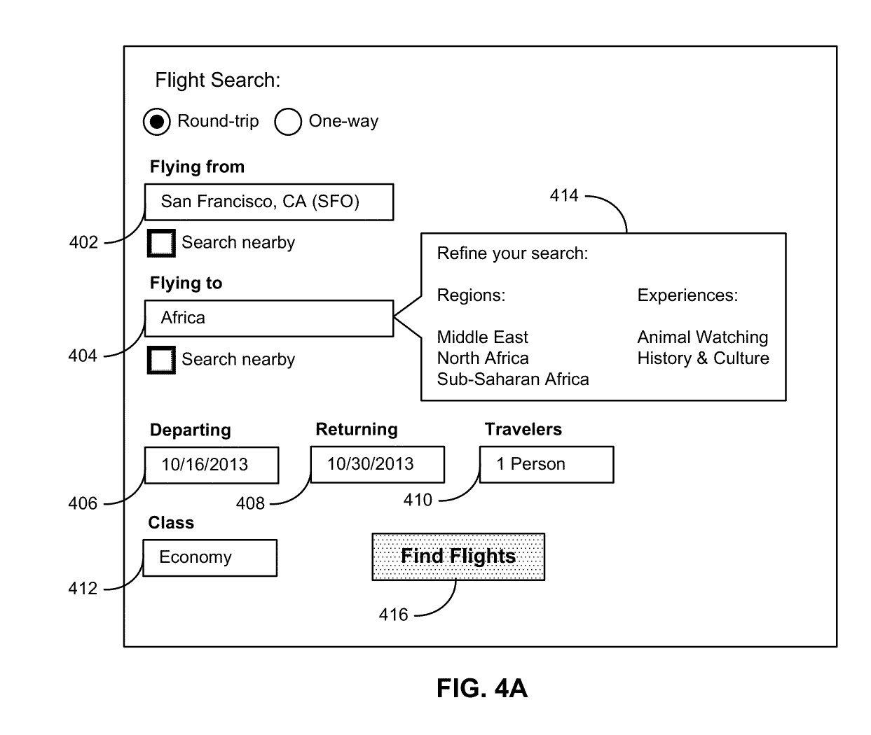

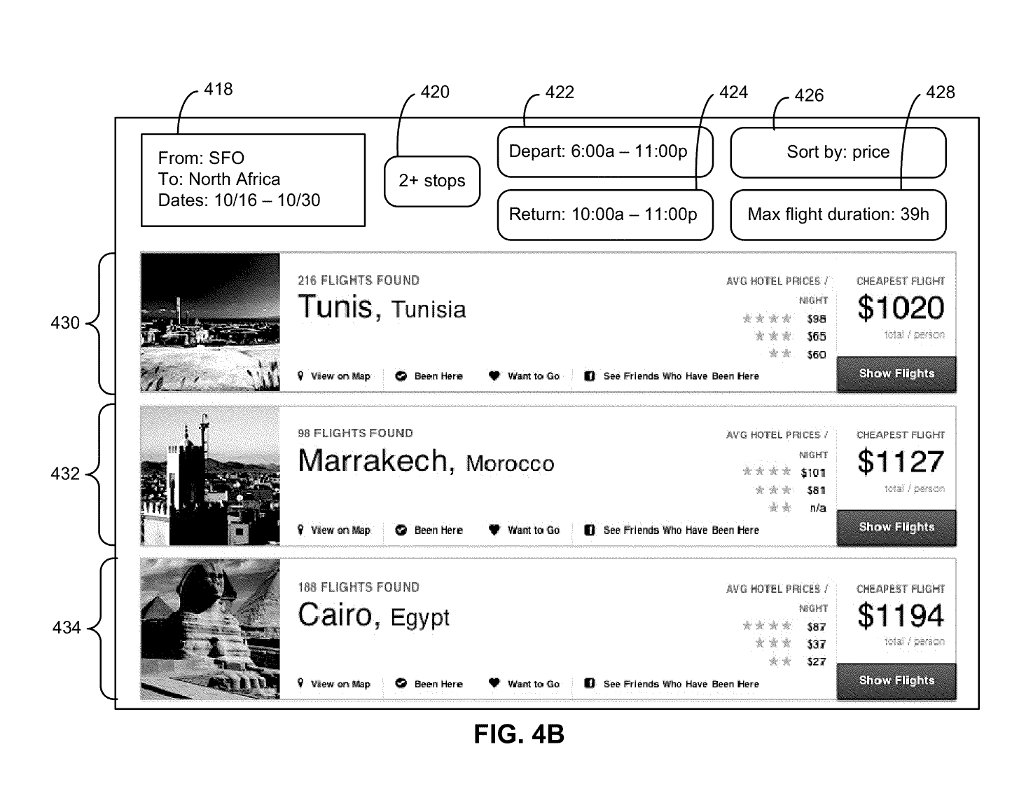

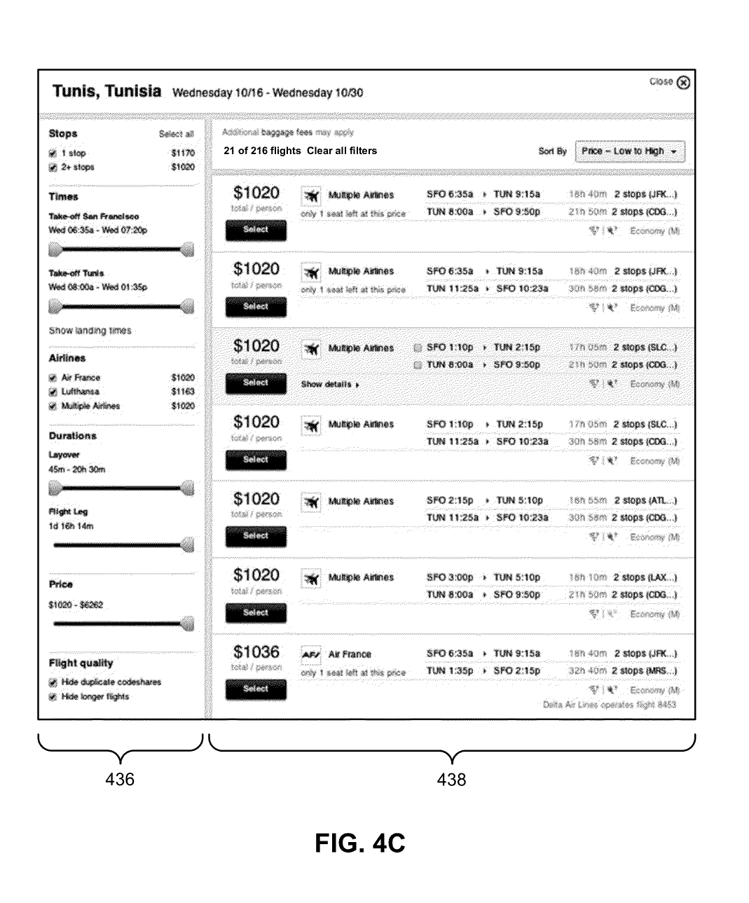

FIG. 4A shows an exemplary screenshot in accordance with the disclosed embodiments. More specifically, FIG. 4A shows a screenshot of a user interface provided by a presentation apparatus, such as presentation apparatus 202 of FIG. 2. The user interface may allow a user to construct a query for a multi-destination search of travel itineraries such as flights.

As shown in FIG. 4A, the user interface includes a set of user-interface elements 402-412 for obtaining search parameters of the query from the user. For example, user-interface element 402 may provide a field into which the user may enter an origin (e.g., “San Francisco, Calif. (SFO)”) to search, and user-interface element 404 may provide a field into which the user may enter a destination preference (e.g., “Africa”) related to a set of destinations to search. User-interface elements 406-412 may provide fields that are used to obtain a departure date (e.g., “Oct. 16, 2013”), a return date (e.g., “Oct. 30, 2013”), a number of travelers (e.g., “1 Person”), and a class of travel (e.g., “Economy”), respectively.

The user interface may also include a user-interface element 414 for refining the destination preference specified in user-interface element 404. For example, user-interface element 414 may appear after the user provides the destination preference to narrow the number of destinations to search and/or increase the relevance of the search results to the user. As a result, user-interface element 414 may display a set of refinements to the destination preference that is based on the destination preference. For example, user-interface element 414 may include regions (e.g., “Middle East,” “North Africa,” “Sub-Saharan Africa”) and experiences (e.g., “Animal Watching,” “History & Culture”) related to the “Africa” destination preference. To add a refinement to the destination preference, the user may select the refinement within user-interface element 414.

The user may select a user-interface element 416 (e.g., “Find Flights”) to conduct a multi-destination search using the parameters provided in user-interface elements 402-414. The user may then browse, sort, and/or update search results of the search through the user interface, as described in further detail below with respect to FIG. 4B.

FIG. 4B shows an exemplary screenshot in accordance with the disclosed embodiments. More specifically, FIG. 4B shows a screenshot of the user interface of FIG. 4A after the user has submitted the query using user-interface element 416. As shown in FIG. 4B, the user interface includes a set of search results 430-434 for the query provided in FIG. 4A.

Search results 430-434 are shown as a set of vertically stacked “blocks” representing different destinations (e.g., “Tunis, Tunisia,” “Marrakech, Morocco,” “Cairo, Egypt”) that match the query. Each block may include a summary of information related to available travel itineraries to the corresponding destination. For example, each block may specify the cheapest flight to the destination, the average hotel prices for hotels at the destination, and/or the number of flights found for the destination. The user may select one or more regions within the block to access a destination-specific list of travel itineraries, as described in further detail below with respect to FIG. 4C. The user may also select other regions of the block to, for example, view the destination on a map, indicate that the user has been to the destination, indicate that the user would like to go to the destination, and/or view friends who have been to the destination. The latter assumes integration with one or more of the social networks, such as Facebook.

A set of user-interface elements 418-428 is also displayed above search results 430-434. User-interface elements 418-428 may include search parameters and/or details associated with available travel itineraries to the destinations. For example, user-interface element 418 may indicate an origin of “SFO,” a destination of “North Africa” (e.g., after the user has selected the “North Africa” refinement in the user interface of FIG. 4A), and travel dates of “October 16-October 30.” User-interface element 420 may indicate a maximum number of “2+stops” for the available travel itineraries. User-interface elements 422-424 may specify the ranges of departure times (e.g., “6:00a-11:00p”) and return times (e.g., “10:00a-11:00p”) found in the available travel itineraries. User-interface element 426 may describe the attribute (e.g., “price”) by which search results 430-434 are sorted. Finally, user-interface element 428 may show a maximum flight duration of “39 h” for the available travel itineraries.

User-interface elements 418-429 may also provide drop-down menus and/or other mechanisms that are used to update, filter, and/or sort search results 430-434. For example, the user may select user-interface element 418 to modify the origin(s), destination(s), and/or travel dates of the query. Similarly, the user may select user-interface elements 420-424 to adjust the maximum number of stops, departure times, and/or arrival times of available travel itineraries shown in search results 430-434. The user may additionally select user-interface element 426 to sort search results 430-434 by a different attribute (e.g., relevance, distance, flight duration, departure time, arrival time, number of stops, name, etc.). Finally, the user may select user-interface element 428 to filter out available travel itineraries that exceed a maximum flight duration from search results 430-434. Those skilled in the art will appreciate that filters represented by user-interface elements 418-428 may be applied to the available itineraries 314 across all destinations shown in search results 430-434.

FIG. 4C shows an exemplary screenshot in accordance with the disclosed embodiments. In particular, FIG. 4C shows a screenshot of the user interface of FIG. 4B after the user has selected search result 430. In response to the user's selection, the user interface may be updated with a modal window, as shown in FIG. 4C.

The modal window includes two regions 436-438. Region 438 may include a list of available travel itineraries to the destination (e.g., “Tunis, Tunisia”) associated with search result 430. Each element in the list may include details of a travel itinerary to the destination, including a price, one or more operating carriers (e.g., airlines), departure and arrival times for each leg of the travel itinerary, total travel times for each leg of the itinerary, and the number of stops for each leg of the travel itinerary. The user may select the element to view additional information for the travel itinerary and/or book the travel itinerary.

Region 436 may provide a set of filters for the travel itineraries shown in region 438. For example, region 436 may allow the user to filter the travel itineraries by number of stops, departure times, arrival times, airlines, layover times, flight leg times, and/or price. Region 436 may also allow the user to remove duplicate codeshares and/or longer flights from region 438. Changes to filters in region 436 may be reflected in search result 430 in the user interface of FIG. 4B but not in search results 432-434 for other destinations.

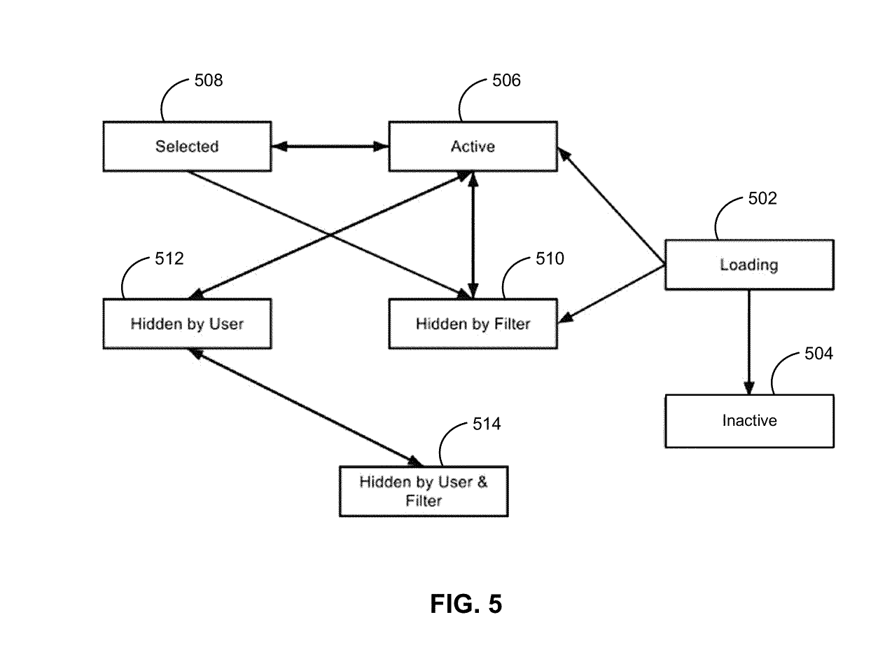

FIG. 5 shows a state diagram for a search result in a results module (e.g., results module 212 of FIG. 2) in accordance with the disclosed embodiments. As described above, the search result may be shown as a “block” containing a summary of available travel itineraries to a destination, along with other blocks containing summaries for available travel itineraries to other destinations that match a user's multi-destination search.

During the search for available travel itineraries to the destination, the block may enter a loading 502 state. If no available travel itineraries to the destination are found, the block may transition to an inactive 504 state. If one or more available travel itineraries to the destination are found, the block may transition to an active 506 state.

The user may then interact with the block in active 506 state. For example, the user may select the block and cause the block to enter a selected 508 state, which may trigger the display of additional information related to the available travel itineraries for the destination. From selected 508 state, the block may be hidden by a filter and enter a hidden by filter 510 state. The block may transition back to active 506 after the filter is removed and/or adjusted to include available travel itineraries to the destination.

The block may also enter hidden by filter 510 state from active 506 (e.g., after the user adjusts filters for the search results), or the block may be manually hidden by the user and enter hidden by user 512 state. The block may further enter a hidden by user & filter 514 state if the block is first hidden by the user, then hidden by a filter after the user adjusts the filter. The block may exit hidden by user & filter 514 state only after the filter is removed, transitioning the block to hidden by user 512 state. The block may then revert to active 506 after the user unhides the block.

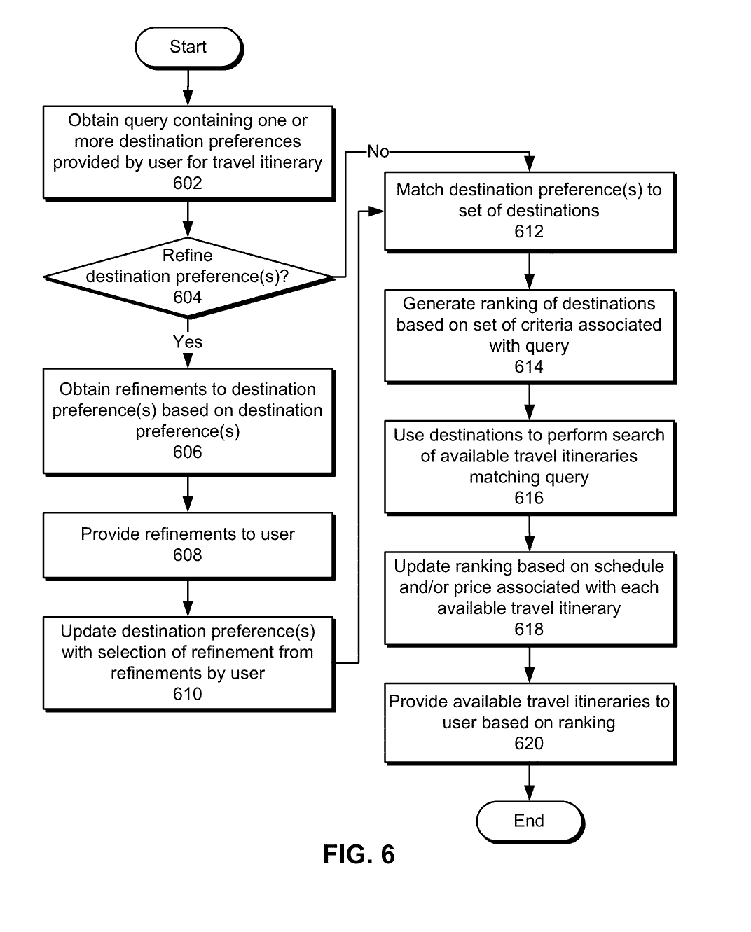

FIG. 6 shows a flowchart illustrating the process of facilitating a purchase of a travel itinerary in accordance with the disclosed embodiments. In one or more embodiments, one or more of the steps may be omitted, repeated, and/or performed in a different order. Accordingly, the specific arrangement of steps shown in FIG. 6 should not be construed as limiting the scope of the embodiments.

Initially, a query containing one or more destination preferences provided by a user for the travel itinerary is obtained (operation 602). The destination preferences may include a region, an experience, and/or a search operator. The destination preference(s) may also be refined (operation 604). For example, the destination preference(s) may be refined to increase the specificity of the query and/or reduce the number of destinations matching the query.

If the destination preference(s) are to be refined, a set of refinements to the destination preference(s) is obtained based on the destination preference(s) (operation 606). The refinements may include additional regions, experiences, and/or sub-regions that are pertinent to the destination preference(s). The refinements are provided to the user (operation 608), and the destination preference(s) are updated with a selection of a refinement from the set of refinements by the user (operation 610).

The destination preference(s), with or without refinements, are then matched to a set of destinations (operation 612). For example, the set of destinations may include one or more destinations explicitly specified by the user and/or one or more destinations that match some or all of the destination preference(s). Next, a ranking of the destinations is generated based on a set of criteria associated with the query (operation 614). The criteria may include the region and/or experience specified in the destination preference(s), a primary season, a length of stay, a distance between the origin in the query and each destination, a time difference between the origin and destination, a popularity, a traveler-friendliness, a child-friendliness, a price, a schedule convenience, and/or a user preference. To generate the ranking, the criteria may be used to calculate a set of match scores for the set of destinations, and the destinations may be ordered by the match scores.

The destinations are used to perform a search of available travel itineraries matching the query (operation 616). For example, the available travel itineraries may be searched for a subset of the ordered destinations associated with higher match scores. The ranking may then be updated based on a schedule and/or price associated with each available travel itinerary (operation 618). For example, the match score for a destination may be increased if the destination is associated with relatively short, convenient, and/or cheap travel itineraries.

Finally, the available travel itineraries are provided to the user based on the ranking (operation 620). For example, the destinations associated with the available travel itineraries may be displayed according to the ordering of the destinations (e.g., by match score), and searching of one or more destinations from a remainder of the ordered destinations not in the subset of the ordered destinations may be enabled. A cheapest price for booking the travel itinerary to each of the destinations may also be displayed (e.g., within a summary of available travel itineraries to each destination). In addition, the displayed destinations may be filtered by the match scores and/or updated based on input from the user, which may be associated with a destination, a travel option, and/or a user action. The ordering of the destinations may further be updated based on a property associated with the available itineraries, such as price, relevance, schedule, departure time, arrival time, name, and/or region.

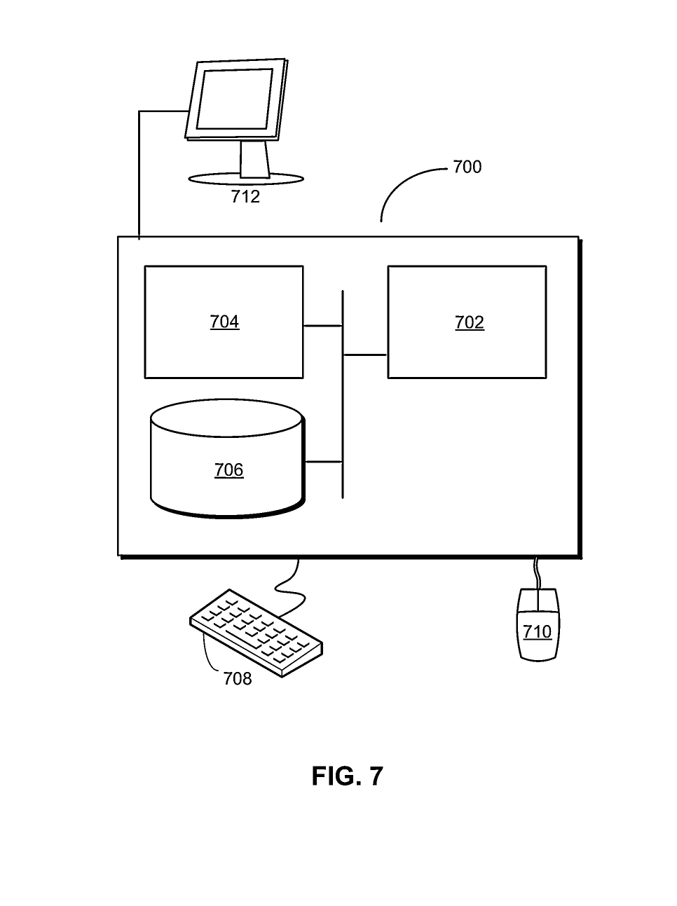

FIG. 7 shows a computer system 700 in accordance with an embodiment. Computer system 700 may correspond to an apparatus that includes a processor 702, memory 704, storage 706, and/or other components found in electronic computing devices such as personal computers, laptop computers, workstations, servers, mobile phones, tablet computers, and/or portable media players. Processor 702 may support parallel processing and/or multi-threaded operation with other processors in computer system 700. Computer system 700 may also include input/output (I/O) devices such as a keyboard 708, a mouse 710, and a display 712.

Computer system 700 may include functionality to execute various components of the present embodiments. In particular, computer system 700 may include an operating system (not shown) that coordinates the use of hardware and software resources on computer system 700, as well as one or more applications that perform specialized tasks for the user. To perform tasks for the user, applications may obtain the use of hardware resources on computer system 700 from the operating system, as well as interact with the user through a hardware and/or software framework provided by the operating system.

In one or more embodiments, computer system 700 provides a system for facilitating a purchase of a travel itinerary. The system may include an analysis apparatus that matches one or more destination preferences from a query for the travel itinerary to a set of destinations. The destination preferences may include a region and/or an experience. Next, the analysis apparatus may generate a ranking of the destinations based on a set of criteria associated with the query. The system may also include a search apparatus that uses the set of destinations to perform a search of available travel itineraries matching the query. Finally, the system may include a presentation apparatus that obtains the query from a user and provides the available travel itineraries to the user based on the ranking.

In addition, one or more components of computer system 700 may be remotely located and connected to the other components over a network. Portions of the present embodiments (e.g., presentation apparatus, analysis apparatus, search apparatus, processing apparatus, etc.) may also be located on different nodes of a distributed system that implements the embodiments. For example, the present embodiments may be implemented using a cloud computing system that facilitates travel booking for a set of remote users by allowing the users to perform multi-destination searches of available travel itineraries.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for facilitating a purchase of a travel itinerary, comprising:
obtaining a query comprising one or more destination preferences provided by a user for the travel itinerary, wherein the one or more destination preferences comprise at least one of a region and an experience;
matching the one or more destination preferences to a set of destinations;
generating a ranking of the destinations based on a set of criteria associated with the query;
using the set of destinations to perform a search of available travel itineraries matching the query; and
providing the available travel itineraries to the user based on the ranking.

2. The computer-implemented method of claim 1, further comprising:
upon receiving the available travel itineraries from the search, updating the ranking of the destinations based on at least one of a schedule and a price associated with each of the available travel itineraries.

3. The computer-implemented method of claim 1, further comprising:
obtaining a set of refinements to the one or more destination preferences based on the one or more destination preferences;
providing the set of refinements to the user; and
updating the one or more destination preferences with a selection of a refinement from the set of refinements by the user prior to matching the one or more destination preferences to the set of destinations.

4. The computer-implemented method of claim 3, wherein the set of refinements comprises at least one of:
one or more regions;
one or more experiences; and
one or more sub-regions.

5. The computer-implemented method of claim 1, wherein generating the ranking of the destinations based on the set of criteria involves:
using the criteria to calculate a set of match scores for the set of destinations; and
ordering the destinations by the match scores.

6. The computer-implemented method of claim 5, wherein using the set of destinations to perform the search of available travel itineraries matching the query involves:
searching the available travel itineraries for a subset of the ordered destinations associated with higher match scores.

7. The computer-implemented method of claim 6, wherein providing the available travel itineraries to the user based on the ranking involves at least one of:
displaying the destinations associated with the available travel itineraries according to the ordering of the destinations;
enabling searching of one or more destinations from a remainder of the ordered destinations not in the subset of the ordered destinations;
displaying a cheapest price for booking the travel itinerary to each of the destinations;
filtering the displayed destinations by the match scores;
updating the displayed destinations based on input from the user; and
updating the ordering of the destinations based on a property associated with the available itineraries.

8. The computer-implemented method of claim 7, wherein the input is associated with at least one of:
a destination;
a travel option; and
a user action.

9. The computer-implemented method of claim 1, wherein the one or more destination preferences further comprise a search operator.

10. The computer-implemented method of claim 1, wherein the set of criteria is associated with at least one of:
the region;
the experience;
a primary season;
a length of stay;
a distance between an origin and a destination of the travel itinerary;
a time difference between the origin and destination;
a popularity;
a traveler-friendliness;
a child-friendliness;
a price;
a schedule convenience; and
a user preference.

11. A system for facilitating a purchase of a travel itinerary, comprising:
an analysis apparatus configured to:
match one or more destination preferences from a query for the travel itinerary to a set of destinations, wherein the one or more destination preferences comprise at least one of a region and an experience;
generate a ranking of the destinations based on a set of criteria associated with the query;
a search apparatus configured to use the set of destinations to perform a search of available travel itineraries matching the query; and
a presentation apparatus configured to:
obtain the query from a user; and
provide the available travel itineraries to the user based on the ranking.

12. The system of claim 11,
wherein the presentation apparatus is further configured to:
obtain a set of refinements to the one or more destination preferences based on the one or more destination preferences; and
provide the set of refinements to the user, and
wherein the analysis apparatus is further configured to update the one or more destination preferences with a selection of a refinement from the set of refinements by the user prior to matching the one or more destination preferences to the set of destinations.

13. The system of claim 11,
wherein generating the ranking of the destinations based on the set of criteria involves:
using the criteria to calculate a set of match scores for the set of destinations; and
ordering the destinations by the match scores, and
wherein using the ranking to perform the search of available travel itineraries matching the query involves searching the available travel itineraries for a subset of the ordered destinations associated with higher match scores.

14. The system of claim 13, wherein providing the available travel itineraries to the user based on the ranking involves at least one of:
displaying the destinations associated with the available itineraries according to the ordering of the destinations;
enabling searching of one or more destinations from a remainder of the ordered destinations not in the subset of the ordered destinations;
displaying a cheapest price for booking the travel itinerary to each of the destinations;
filtering the displayed destinations by the match scores;
updating the displayed destinations based on input from the user; and
updating the ordering of the destinations based on a property associated with the available itineraries.

15. The system of claim 11, wherein the set of criteria is associated with at least one of:
the region;
the experience;
a primary season;
a length of stay;
a distance between an origin and a destination of the travel itinerary;
a time difference between the origin and destination;
a popularity;
a traveler-friendliness;
a child-friendliness;
a price;
a schedule convenience; and
a user preference.

16. A non-transitory computer-readable storage medium storing instructions that when executed by a computer cause the computer to perform a method for facilitating a purchase of a travel itinerary, the method comprising:
obtaining a query comprising one or more destination preferences provided by a user for the travel itinerary, wherein the one or more destination preferences comprise at least one of a region and an experience;
matching the one or more destination preferences to a set of destinations;
generating a ranking of the destinations based on a set of criteria associated with the query;
using the set of destinations to perform a search of available travel itineraries matching the query; and
providing the available travel itineraries to the user based on the ranking.

17. The non-transitory computer-readable storage medium of claim 16, the method further comprising:
upon receiving the available travel itineraries from the search, updating the ranking of the destinations based on at least one of a schedule and a price associated with each of the available travel itineraries.

18. The non-transitory computer-readable storage medium of claim 16, the method further comprising:
obtaining a set of refinements to the one or more destination preferences based on the one or more destination preferences;
providing the set of refinements to the user; and
updating the one or more destination preferences with a selection of a refinement from the set of refinements by the user prior to matching the one or more destination preferences to the set of destinations.

19. The non-transitory computer-readable storage medium of claim 16,
wherein generating the ranking of the destinations based on the set of criteria involves:
using the criteria to calculate a set of match scores for the set of destinations; and
ordering the destinations by the match scores, and
wherein using the ranking to perform the search of available travel itineraries matching the query involves searching the available travel itineraries for a subset of the ordered destinations associated with higher match scores.

20. The non-transitory computer-readable storage medium of claim 19, wherein providing the available travel itineraries to the user based on the ranking involves at least one of:
displaying the destinations associated with the available itineraries according to the ordering of the destinations;
enabling searching of one or more destinations from a remainder of the ordered destinations not in the subset of the ordered destinations;
displaying a cheapest price for booking the travel itinerary to each of the destinations;
filtering the displayed destinations by the match scores;
updating the displayed destinations based on input from the user; and
updating the ordering of the destinations based on a property associated with the available itineraries.
